(19) United States
(12) Patent Application Publication
(10) Pub. No.: US 2025/0342074 A1
(43) Pub. Date: Nov. 6, 2025

(54) UNBOUNDED FRAME DETECTION

(71) Applicant: QUALCOMM Incorporated, San Diego, CA (US)

(72) Inventors: Nitin SRIVASTAVA, San Diego, CA (US); Mayank MANGLA, Allen, TX (US); Alok Kumar PANDEY, Hyderabad (IN)

(21) Appl. No.: 18/655,641

(22) Filed: May 6, 2024

(51) Int. Cl. G06F 11/07; G06F 11/14; H04N 7/088

(52) U.S. Cl. CPC G06F 11/0757; G06F 11/1441; H04N 7/0881

(57) ABSTRACT

A device includes memory configured to store image frame data of an image frame. The device also includes one or more processors configured to initiate a timer based on receiving a frame start indication of the image frame, the timer configured to expire after an expected receipt time of a frame end indication. The one or more processors are also configured to receive, via a communication link, the image frame data subsequent to receiving the frame start indication. The one or more processors are further configured to, responsive to expiration of the timer, initiate a reset operation corresponding to an error in receipt of the frame end indication.

### I. FIELD

The present disclosure is generally related to unbounded frame detection.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to receive images from one or more cameras. For example, a device may receive multiple packets from a camera over a communication link, with each of the packets including some data of an image frame. The camera sends a frame start indication prior to sending the packets and a frame end indication subsequent to the sending the packets. The device, in response to receiving the frame start indication, allocates space in memory for the image frame and stores data from the packets in the memory until the frame end indication is received.

In some situations, e.g., due to a lossy communication channel, an image frame can become “unbounded” at a device, such as when the frame end indication for the image frame is not timely received at the device subsequent to receipt of the frame start indication for the image frame. One or more hardware blocks can enter an undefined state in such circumstances, leading to image data loss at the device.

### III. Summary

According to one implementation of the present disclosure, a device includes memory configured to store image frame data of an image frame. The device also includes one or more processors configured to initiate a timer based on receiving a frame start indication of the image frame, the timer configured to expire after an expected receipt time of a frame end indication. The one or more processors are also configured to receive, via a communication link, the image frame data subsequent to receiving the frame start indication. The one or more processors are further configured to, responsive to expiration of the timer, initiate a reset operation corresponding to an error in receipt of the frame end indication.

According to another implementation of the present disclosure, a non-transitory computer-readable medium stores instructions that, when executed by one or more processors, cause the one or more processors to initiate a timer based on receiving a frame start indication of an image frame, the timer configured to expire after an expected receipt time of a frame end indication. The instructions also cause the one or more processors to receive, via a communication link, image frame data of the image frame subsequent to receiving the frame start indication. The instructions further cause the one or more processors to, responsive to expiration of the timer, initiate a reset operation corresponding to an error in receipt of the frame end indication.

According to another implementation of the present disclosure, a method includes initiating, at a device, a timer based on receiving a frame start indication of an image frame, the timer configured to expire after an expected receipt time of a frame end indication. The method also includes receiving, at the device via a communication link, image frame data of the image frame subsequent to receiving the frame start indication. The method further includes, responsive to expiration of the timer, initiating a reset operation corresponding to an error in receipt of the frame end indication.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to perform unbounded frame detection, in accordance with some examples of the present disclosure.

FIG. 2 is a diagram of an illustrative aspect of operations associated with receiving a bounded frame that may be performed by the system of FIG. 1, in accordance with some examples of the present disclosure.

FIG. 3 is a diagram of an illustrative aspect of operations associated with detecting an unbounded frame that may be performed by the system of FIG. 1, in accordance with some examples of the present disclosure.

FIG. 4 is a diagram of another illustrative aspect of operations associated with detecting an unbounded frame that may be performed by the system of FIG. 1, in accordance with some examples of the present disclosure.

FIG. 5 illustrates various electronic devices operable to perform unbounded frame detection, in accordance with some examples of the present disclosure.

FIG. 6 is a diagram of a particular implementation of a method of unbounded frame detection that may be performed by the system of FIG. 1, in accordance with some examples of the present disclosure.

FIG. 7 is a block diagram of a particular illustrative example of a device that is operable to perform unbounded frame detection, in accordance with some examples of the present disclosure.

### V. DETAILED DESCRIPTION

A device receives images from one or more cameras. For example, a device may receive multiple packets from a camera, with each of the packets including some data of an image frame. For example, a camera may send, to a device, a first frame start indication, followed by one or more first packets that include first data of a first image frame, and then a first frame end indication. Subsequently, the camera may send, to the device, a second frame start indication, followed by one or more second packets that include second data of a second image frame, and then a second frame end indication.

In a first example, the image frames are correctly received at the device. To illustrate, the device, subsequent to receiving the first frame start indication, allocates a memory portion for the first image frame. The device stores data in the memory portion from one or more packets received subsequent to receiving the first frame start indication and prior to receiving the first frame end indication. When the first frame end indication is received, the device designates the stored data as corresponding to (e.g., representing) the first image frame and initiates a frame end reset operation corresponding to receipt of the first frame end indication. Similarly, the device, subsequent to receiving the second frame start indication, allocates a memory portion for the second image frame. The device stores data in the memory portion from one or more packets received subsequent to receiving the second frame start indication and prior to receiving the second frame end indication. When the second frame end indication is received, the device designates the stored data as corresponding to (e.g., representing) the second image frame and initiates a frame end reset operation corresponding to receipt of the second frame end indication.

In a second example, the first image frame is unbounded at the device, e.g., due to a lossy communication channel. For example, the first frame end indication is not received timely at the device subsequent to receipt of the first frame start indication. One or more hardware blocks associated with receiving image data via the communication link may enter an undefined state when the first frame end indication is not received timely.

In some cases, the second frame start indication is not received, or receipt of the second frame start indication is not detected while the hardware blocks are in an undefined state or are being reset. The device continues to receive packets that include data of the second image frame and attempts to store the data in the memory portion with the data of the first image frame. The device, in response to a memory overflow, designates the stored data as invalid, even when data for one or both image frames is received correctly at the device.

Systems and methods of unbounded frame detection are disclosed. For example, an image data controller, in response to receiving a frame start indication of an image frame via a communication link, initiates a timer to expire at an expiration time that is after an expected receipt time of a frame end indication of the image frame. The image data controller allocates a memory portion to store data for the image frame. The image data controller, in response to receiving one or more packets via the communication link subsequent to receipt of the frame start indication, stores data of the one or more packets in the allocated memory portion.

If the frame end indication is received at the device via the communication link prior to the expiration time, the image data controller cancels the timer, designates the stored data as valid and representative of the image frame, and initiates a frame end reset operation corresponding to receipt of the frame end indication. Alternatively, if the timer expires prior to receipt of a frame end indication, the image data controller detects an unbounded image frame, designates the stored data as invalid, and initiates an error reset operation that corresponds to an error in receipt of the frame end indication. The error reset operation can include resetting one or more hardware blocks associated with receiving the image data via the communication link. The error reset operation completes prior to an expected receipt time of a next frame start indication. The image data controller recovers from the unbounded frame error prior to receiving a next frame start indication, the unbounded image frame thus resulting in loss of a single image frame instead of multiple image frames.

An image frame includes rows and columns of pixels. Each row of pixels corresponds to an image line, and each packet includes image data corresponding to a respective image line. In some implementations, the image data controller maintains a line counter. For example, the image data controller initializes the line counter (e.g., to 0) in response to receiving the frame start indication, and updates the line counter (e.g., by 1) in response to receiving a packet. The image data controller, in response to detecting the unbounded image frame and determining that the value of the line counter matches an expected line count, designates the stored data as valid and representative of the image frame. Alternatively, the image data controller, in response to detecting the unbounded image frame and determining that the value of the line counter does not match the expected line count, designates the stored data as invalid. Independently of whether the stored data is designated as valid or invalid, the image data controller, in response to detecting an unbounded image frame, initiates an error reset operation that corresponds to an error in receipt of the frame end indication. The error reset operation completes prior to an expected receipt time of a next frame start indication. The image data controller can thus recover from the unbounded frame error without loss of any image frame if the value of the line counter matches the expected line count.

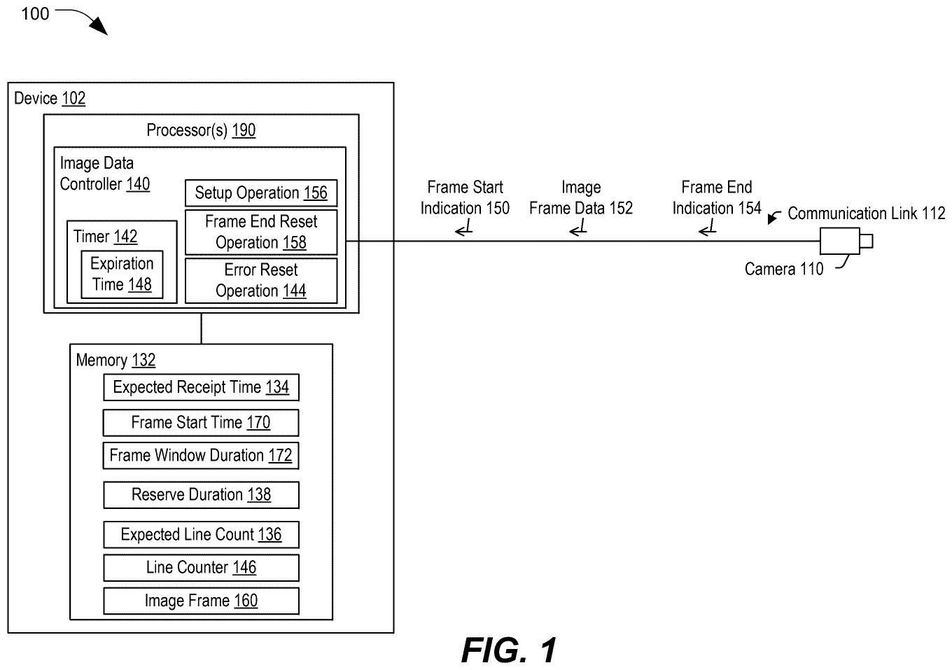

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

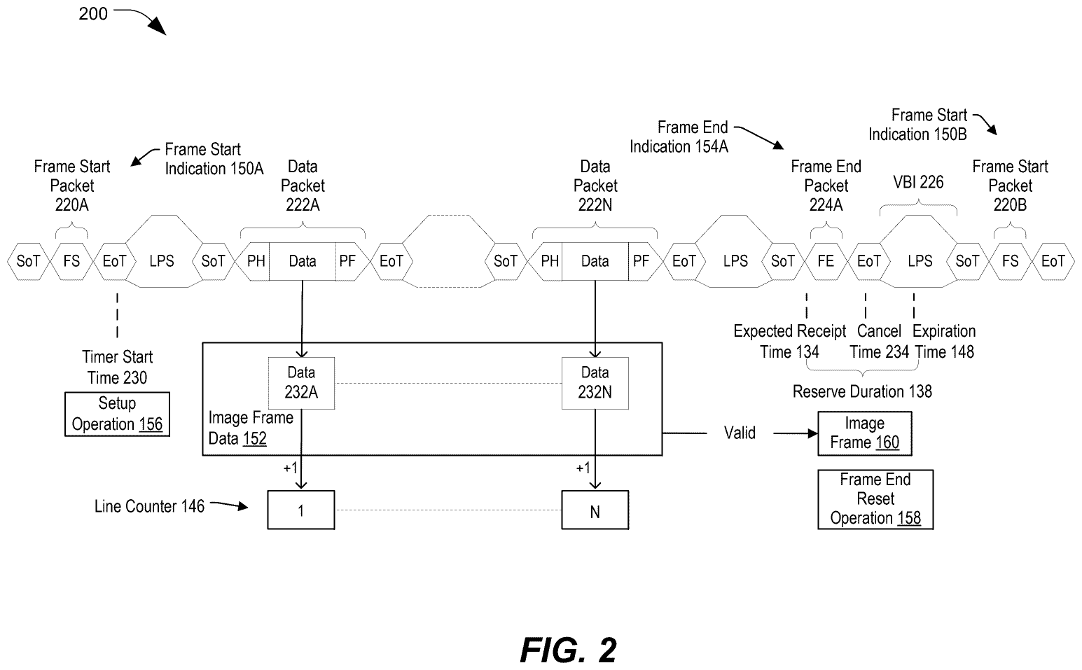

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 2, multiple frame start indications 150 are illustrated and associated with reference numbers 150A and 150B. When referring to a particular one of these frame start indications, such as a frame start indication 150A, the distinguishing letter “A” is used. However, when referring to any arbitrary one of these frame start indications or to these frame start indications as a group, the reference number 150 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a central processing unit (CPU) typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations of a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processors ability to perform particular types of operations. For example, the logic gates, local memory circuits, and the interconnects therebetween of a graphics processing unit (GPU) are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

A processor can be configured to perform a specific task by including, within the processor, specialized hardware to perform the task. Additionally, or alternatively, the processor can be configured to perform a specific task by loading and/or executing instructions (e.g., computer code) that, when executed, cause the processor to perform the specific task. Loading executable instructions to perform the task causes an internal configuration change in the processor that transforms what may otherwise be a general-purpose processor into a special purpose processor for performing the task.

Referring to FIG. 1, a particular illustrative aspect of a system 100 configured to perform unbounded frame detection is depicted, in accordance with some examples of the present disclosure. The system 100 includes a device 102 that is coupled via a communication link 112 to a camera 110. The communication link 112 can include a wired communication link, a wireless communication link, or both. Although the camera 110 is depicted as external to the device 102, in other aspects the camera 110 is integrated into the device 102.

The device 102 includes one or more processors 190 coupled to a memory 132. The memory 132 is configured to store data associated with communication of image data from the camera 110, such as an expected receipt time 134, a reserve duration 138, an expected line count 136, a line counter 146, image frame data 152 of an image frame 160, a frame start time 170, a frame window duration 172, or a combination thereof.

The one or more processors 190 include an image data controller 140 configured to perform unbounded frame detection. For example, the image data controller 140 is configured to perform a setup operation 156 in response to receiving a frame start indication 150. The setup operation 156 includes initiating a timer 142 to expire at an expiration time 148 that is after an expected receipt time 134 of a frame end indication, as further described with reference to FIG. 2. In some aspects, the setup operation 156 includes allocating a portion of the memory 132 to store data associated with the image frame 160. Optionally, in some implementations, the setup operation 156 includes, in response to receiving the frame start indication 150, initializing the line counter 146 (e.g., to 0) that is to be used to track a count of lines of the image frame 160 received at the device 102.

The image data controller 140 is configured to, in response to receiving image frame data 152 subsequent to performing the setup operation 156, store the image frame data 152 in the memory 132 (e.g., in the allocated portion of the memory 132). Optionally, in some implementations, the image data controller 140 is configured to update the line counter 146 in response to receiving the image frame data 152, as further described with reference to FIG. 2.

The image data controller 140 is configured to, in response to receiving a frame end indication 154 prior to expiration of the timer 142 (e.g., prior to the expiration time 148), cancel the timer 142 and designate the stored image frame data 152 as valid and a representation of the image frame 160, as further described with reference to FIG. 2. In some aspects the image data controller 140 is configured to, responsive to receiving the frame end indication 154 prior to expiration of the timer 142, perform a frame end reset operation 158 corresponding to receipt of the frame end indication 154. For example, the image data controller 140 is configured to, during the frame end reset operation 158, reset one or more hardware blocks associated with receiving the image frame data 152 via the communication link 112.

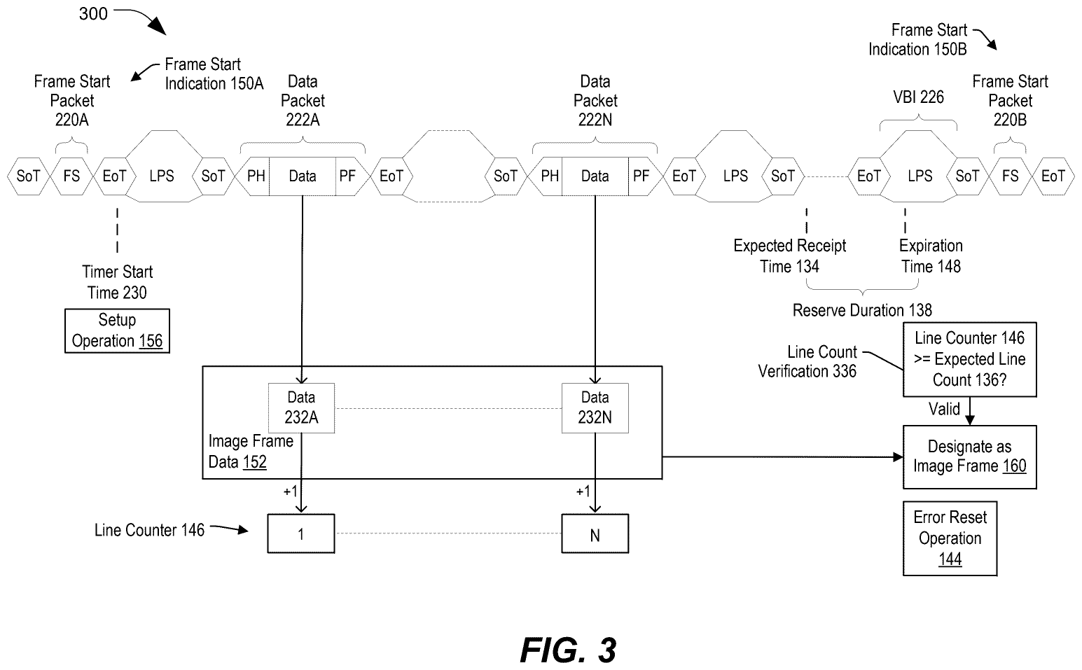

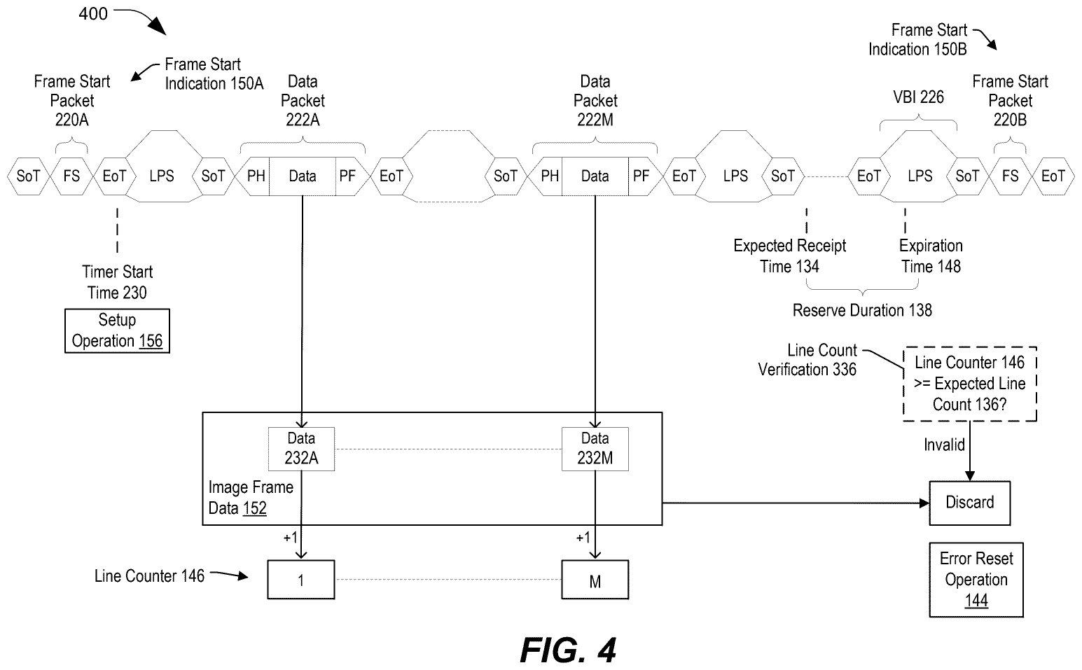

Alternatively, in response to expiration of the timer 142 prior to receipt of the frame end indication 154, the image data controller 140 is configured to detect an unbounded frame. In implementations in which the image data controller 140 uses the line counter 146 to track a count of image lines received, the image data controller 140 is configured to, in response to detecting an unbounded frame, compare a value of the line counter 146 to the expected line count 136 to determine whether the stored image frame data 152 is valid, as further described with reference to FIGS. 3 and 4. In implementations in which the image data controller 140 does not track a count of image lines received, the image data controller 140 is configured to, in response to detecting an unbounded frame, designate the stored image frame data 152 that was received for the unbounded frame as invalid. The image data controller 140 is also configured to initiate an error reset operation 144 in response to detecting an unbounded frame. For example, the image data controller 140 is configured to, during the error reset operation 144, reset one or more hardware blocks associated with receiving the image frame data 152 via the communication link 112.

During operation, the camera 110 sends one or more image frames via the communication link 112 to the device 102. For example, an image frame 160 corresponds to an output of the camera 110. The camera 110, to send the image frame 160, sends a frame start indication 150, followed by one or more packets including image frame data 152 of the image frame 160, and a frame end indication 154, as further described with reference to FIG. 2. The image data controller 140 performs a setup operation 156 in response to receiving the frame start indication 150. For example, the setup operation 156 includes initiating a timer 142 to expire at an expiration time 148 that is after an expected receipt time 134 of the frame end indication 154.

To illustrate, the image data controller 140 determines that the frame start indication 150 is received at the device 102 via the communication link 112 at a frame start time 170. The image data controller 140 determines, based on a sum of the frame start time 170 and a frame window duration 172, an expected receipt time 134 of the frame end indication 154. The frame window duration 172 indicates an expected duration between receiving a frame start indication 150 and a corresponding frame end indication 154. The frame window duration 172 can be based on default data, a configuration setting, a user input, or a combination thereof. According to some aspects, the frame window duration 172 may be computed based on frame size information from the camera 110, a data transfer rate of the communication link 112, a number of packets to be transmitted per frame, timing intervals between indications and/or packets, one or more other parameters, or a combination thereof. In some implementations, the frame window duration 172 can be based on a historical duration between receiving a frame start indication 150 and a corresponding frame end indication 154.

The image data controller 140 determines the expiration time 148 based on a sum of the expected receipt time 134 and a reserve duration 138. The reserve duration 138 can be based on default data, a configuration setting, a user input, or a combination thereof. The reserve duration 138 corresponds to extra time (e.g., in milliseconds) to account for a potential delay in receiving the frame end indication 154, detecting receipt of the frame end indication 154, canceling the timer 142, or a combination thereof. The image data controller 140 configures the timer 142 to expire at the expiration time 148.

Optionally, in some implementations, the image data controller 140 initializes a value of the line counter 146 (e.g., 0) during the setup operation 156. In some aspects, the image data controller 140, during the setup operation 156, allocates a portion of the memory 132 to store data to be received of the image frame 160.

Subsequent to receiving the frame start indication 150, the image data controller 140 receives one or more packets including portions of the image frame data 152 of the image frame 160 via the communication link 112, as further described with reference to FIG. 2. The image data controller 140, after performing the setup operation 156, stores the portions of the image frame data 152 in the memory 132 (e.g., the allocated portion of the memory 132). Optionally, in some implementations, the image data controller 140 updates the value of the line counter 146 in response to receiving portions of the image frame data 152 to indicate a count of image lines received at the device 102, as further described with reference to FIG. 2.

In some examples, the frame end indication 154 is received at the device 102 prior to expiration of the timer 142 (e.g., prior to the expiration time 148). The image data controller 140, responsive to receipt of the frame end indication 154 prior to expiration of the timer 142, disables (e.g., cancels) the timer 142, and designates the stored portions of the image frame data 152 as valid and representative of the image frame 160, as further described with reference to FIG. 2. In some aspects, the image data controller 140, responsive to receipt of the frame end indication 154 prior to expiration of the timer 142, initiates a frame end reset operation 158. To illustrate, during the frame end reset operation 158, the image data controller 140 resets one or more hardware blocks of the device 102.

In some examples, the timer 142 expires prior to receipt of the frame end indication 154 at the device 102. For example, the frame end indication 154 can be delayed or lost during transmission over the communication link 112. Optionally, in some implementations, an interrupt is triggered at the device 102 upon expiration of the timer 142. The image data controller 140, responsive to expiration of the timer 142 (e.g., responsive to the interrupt), initiates an error reset operation 144 corresponding to an error in receipt of the frame end indication 154. For example, during the error reset operation 144, the image data controller 140 resets one or more hardware blocks of the device 102.

In some implementations in which the image data controller 140 tracks a count of image lines of the image frame 160 received at the device 102, the image data controller 140, responsive to expiration of the timer 142, compares the value of the line counter 146 and an expected line count 136 to determine whether the portions of the image frame data 152 stored in the memory 132 are valid (e.g., complete), as further described with reference to FIGS. 3 and 4. The image data controller 140, in response to determining that the value of the line counter 146 matches the expected line count 136, designates the portions of the image frame data 152 stored in the memory 132 as valid and representative of the image frame 160, as further described with reference to FIG. 3. Alternatively, the image data controller 140, in response to determining that the value of the line counter 146 does not match the expected line count 136, designates the portions of the image frame data 152 stored in the memory 132 as invalid, as further described with reference to FIG. 4.

In some implementations in which the image data controller 140 does not track a count of image lines of the image frame 160 received at the device 102, the image data controller 140, responsive to expiration of the timer 142, designates the portions of the image frame data 152 stored in the memory 132 as invalid, as further described with reference to FIG. 4. The image data controller 140 completes performance of the error reset operation 144 (or the frame end reset operation 158) prior to the expected receipt time of a next frame start indication 150.

A technical advantage of the system 100 thus includes enabling the device 102 to recover from an unbounded image frame prior to receipt of a next frame start indication. The unbounded image frame does not cause image data of a next image frame to be designated as invalid. In cases in which the value of the line counter 146 matches the expected line count 136, image data of the unbounded image frame is also retained at the device 102 as valid.

It should be understood that the camera 110 is provided as an illustrative example of a frame data source, the image frame data 152 is provided as an illustrative example of frame data, and the image data controller 140 is provided as an illustrative example of a data controller. In some other examples, another type of image frame data source, such as a graphics processor, an artificial intelligence (AI) image generator, or both, can send a frame start indication 150, image frame data 152, and a frame end indication 154 via a communication link 112 to the device 102 to be processed by the image data controller 140.

In some other examples, another type of frame data source, such as an audio frame source, can send a frame start indication 150, frame data (e.g., audio frame data), and a frame end indication 154 via a communication link 112 to the device 102 to be processed by a data controller (e.g., an audio data controller) that performs similar operations as the image data controller 140. For example, the data controller initiates the timer 142 responsive to receiving the frame start indication 150. As another example, in some implementations, the data controller updates a counter (e.g., a packet counter) responsive to receiving a portion of the frame data and performs a comparison of a value of the counter to an expected count (e.g., an expected packet count) responsive to expiration of the timer 142 prior to receipt of the frame end indication 154.

Although various types of data are depicted in the memory 132, it should be understood that one or more of the data types may not be stored in the memory 132. For example, although the line counter 146 is depicted in the memory 132, in other implementations the line counter 146 can be implemented in the image data controller 140 (e.g., as a hardware counter). Alternatively, in some implementations, the line counter 146 (and the expected line count 136) are omitted, in which case expiration of the timer 142 results in invalidation of the stored portions of the image frame data 152 for the image frame 160. As another example, although frame start time 170 and the frame window duration 172 are depicted in the memory 132, in other implementations the frame start time 170, the frame window duration 172, or both, are omitted and the expiration time 148 is directly calculated based on a system clock and a duration parameter that may be hardcoded at the image data controller 140.

Referring to FIG. 2, a diagram 200 is shown of an illustrative aspect of operations associated with receiving a bounded frame that may be performed by the system 100 of FIG. 1, in accordance with some examples of the present disclosure.

The camera 110 of FIG. 1, to send an image frame 160, sends a plurality of packets via the communication link 112 to the device 102. For example, the packets include a frame start (FS) packet 220A that the camera 110 sends to the device 102 as a frame start indication 150A to indicate that the camera 110 is going to start sending data packets of the image frame 160 to the device 102.

After sending the frame start packet 220A, the camera 110 sends a plurality of data packets 222 that represent the image frame 160. The plurality of data packets 222 include a data packet 222A, one or more additional data packets, and a data packet 222N, where N is a positive integer greater than 1. The data packets 222 include respective portions of the image frame data 152 of the image frame 160. For example, the data packet 222A includes data 232A of the image frame data 152. As another example, the data packet 222N includes data 232N of the image frame data 152. Each data packet 222 includes a packet header (PH), a packet footer (PF), or both.

In some implementations, each data packet 222 includes data 232 representing an image line of the image frame 160. For example, the data 232A represents a first image line of the image frame 160, and the data 232N represents an Nth image line of the image frame 160. In this example, the image frame 160 includes N image lines, and the expected line count 136 of FIG. 1 indicates N.

The camera 110, after sending the data packets 222, sends a frame end (FE) packet 224A to the device 102 as a frame end indication 154A to indicate that the camera 110 has completed sending of the image frame 160. After sending the frame end packet 224A, the camera 110 can send a next image frame if there are additional image frames to be sent. For example, the camera 110 can send a frame start packet 220B as a frame start indication 150B to indicate that the camera 110 is going to start sending data packets of the next image frame to the device 102.

Each transmission from the camera 110 via the communication link 112 begins with a start of transmission (SoT) and ends with an end of transmission (EoT). Between an EoT and a next SoT, the communication link 112 enters a low power state (LPS). An interval between an EoT of a data packet 222A and a SoT of a next data packet is referred to as a horizontal blanking interval (HBI) or a line blanking interval. An interval between an EoT of a frame end packet 224A of an image frame 160 and a SoT of a frame start packet 220B of a next image frame is referred to as a vertical blanking interval (VBI) or a frame blanking interval. In a particular aspect, the image frame data 152 includes a stream of packets of image line data interspersed with blanking intervals.

The image data controller 140 initiates a setup operation 156 in response to receiving the frame start packet 220A as the frame start indication 150A for the image frame 160. For example, during the setup operation 156, the image data controller 140 initiates the timer 142 at a timer start time 230 to expire at an expiration time 148 that is after the expected receipt time 134 of the frame end packet 224A and prior to an expected receipt time of a next frame start indication (e.g., the frame start packet 220B), as described with reference to FIG. 1. In some aspects, the expiration time 148 is scheduled to be during an expected VBI 226 after the expected EoT of the frame end packet 224A such that the error reset operation 144 (if the image frame 160 is unbounded) can complete during the expected VBI 226 and prior to an SoT of the frame start packet 220B.

In some implementations, the image data controller 140, during the setup operation 156, initializes the line counter 146 to have a particular value (e.g., 0) indicating that no image lines have been received at the device 102. In some aspects, the image data controller 140, during the setup operation 156, allocates a portion of the memory 132 to be used to store received data as associated with the image frame data 152.

The image data controller 140, in response to receiving data packets 222, stores received portions of the image frame data 152 in the allocated portion of the memory 132. For example, the image data controller 140, in response to receiving the data packet 222A via the communication link 112 after receiving the frame start packet 220A, stores the data 232A of the data packet 222A in the allocated portion of the memory 132 as a portion of the image frame data 152. As another example, the image data controller 140, in response to receiving the data packet 222N via the communication link 112, stores the data 232N of the data packet 222N in the allocated portion of the memory 132 as a portion of the image frame data 152.

In implementations in which the image data controller 140 tracks a count of image lines received at the device 102, the image data controller 140 updates the line counter 146 based on receiving a data packet 222 of image line data. For example, the image data controller 140, in response to receiving the data packet 222A representing a line of the image frame 160, increments the line counter 146 (e.g., by 1) to indicate a count of image lines (e.g., 1) received at the device 102. As another example, the image data controller 140, in response to receiving the data packet 222N representing a line of the image frame 160, increments the line counter 146 (e.g., by 1) to indicate a cumulative count (e.g., N) of image lines of the image frame 160 that have been received at the device 102.

The image data controller 140, responsive to receiving the frame end packet 224A as the frame end indication 154A prior to expiration of the timer 142 (e.g., prior to the expiration time 148), determines that the image frame 160 is a bounded frame and disables the timer 142 at a cancel time 234. In some implementations, the image data controller 140 also initiates a frame end reset operation 158 corresponding to receipt of the frame end indication 154A. For example, during the frame end reset operation 158, the image data controller 140 resets one or more hardware blocks that are associated with receiving packets (e.g., the frame start packets 220, the data packets 222, the frame end packets 224, or a combination thereof) via the communication link 112 at the device 102 in preparation of receipt of the next frame start packet 220B.

The image data controller 140, responsive to receiving the frame end packet 224A prior to expiration of the timer 142, designates the portions of the image frame data 152 (e.g., the data 232A, . . . , the data 232N) stored in the allocated portion of the memory 132 as valid and a representation of the image frame 160. Because the image data controller 140 received the frame end packet 224A as the frame end indication 154A prior to the expiration time 148, the data packets 222 received between the frame start packet 220A and the frame end packet 224A are verified as associated with the image frame 160.

In the example illustrated in FIG. 2, all N data packets have been received at the device 102 as shown by the value (e.g., N) of the line counter 146. In another example, one or more data packets 222 may not be received at the device 102. To illustrate, a data packet 222 can be lost in transmission over the communication link 112. Although fewer than N data packets have been received at the device 102, each data packet 222 received between receipt of the frame start packet 220A and receipt of the frame end packet 224A is associated with the image frame 160 and is valid.

Referring to FIG. 3, a diagram 300 is shown of an illustrative aspect of operations associated with detecting an unbounded frame that may be performed by the system 100 of FIG. 1, in accordance with some examples of the present disclosure.

The image data controller 140 receives the frame start packet 220A and the data packets 222 and performs corresponding operations, as described with reference to FIG. 2. However, in FIG. 3, the frame end packet 224A is not timely received at the device 102. For example, the frame end packet 224A is not received at the device 102 prior to expiration of the timer 142. In a particular aspect, an interrupt is triggered at the expiration time 148, indicating that the timer 142 has expired.

The image data controller 140, responsive to expiration of the timer 142 prior to receipt of the frame end packet 224A, determines that the image frame 160 is unbounded and performs an error reset operation 144 during the expected VBI 226. The error reset operation 144 corresponds to an error in receipt of the frame end packet 224A. In a particular aspect, the error corresponds to an unbounded frame error. During the error reset operation 144, the image data controller 140 resets one or more hardware blocks that are associated with receiving packets (e.g., the frame start packets 220, the data packets 222, the frame end packets 224, or a combination thereof) via the communication link 112 at the device 102 in preparation of receiving the next frame start packet (e.g., the frame start packet 220B). According to an aspect, the expiration time 148 is set within the expected VBI 226 to provide sufficient time to complete the error reset operation 144 prior to the start of transmission for the next frame start packet 220B.

The image data controller 140, responsive to expiration of the timer 142 prior to receipt of the frame end packet 224A, performs a line count verification 336 to determine whether the stored portions of the image frame data 152 are valid. For example, during the line count verification 336, the image data controller 140 determines whether a value (e.g., N) of the line counter 146 matches the expected line count 136 (e.g., N). For example, the image data controller 140, in response to determining that the value of the line counter 146 indicates a received line count that matches (e.g., is equal to) the expected line count 136, determines that the portions of the image frame data 152 (e.g., the data 232A, . . . , the data 232N) are valid and representative of the image frame 160.

A technical advantage of using the line counter 146 to track a count of image lines received includes retaining correctly received data of the image frame 160 when the value of the line counter 146 matches the expected line count 136. The portions of the image frame data 152 that are correctly received thus do not have to be discarded.

A technical advantage of configuring the timer 142 to expire at the expiration time 148 that is during the expected VBI 226 includes preventing a memory overflow by preventing data of the next image frame being stored with the data of the image frame 160 even if both the frame end packet 224A and the frame start packet 220B are lost during transmission. Having the timer 142 expire at the expiration time 148 with sufficient time remaining in the VBI 226 to complete the error reset operation 144 includes enabling the device 102 to recover from the unbounded image frame prior to receipt of the frame start packet 220B of a next image frame, and preventing the unbounded image frame from causing data of the next image frame to be discarded.

Referring to FIG. 4, a diagram 400 is shown of an illustrative aspect of operations associated with detecting an unbounded frame that may be performed by the system 100 of FIG. 1, in accordance with some examples of the present disclosure.

The image data controller 140 receives the frame start packet 220A and the data packets 222 and performs corresponding operations, as described with reference to FIG. 2. In a particular implementation, the image data controller 140 receives fewer (e.g., M) packets than all of the N packets representing the image frame 160 prior to expiration of the timer 142. The frame end packet 224A is not received at the device 102 prior to expiration of the timer 142.

The image data controller 140, responsive to expiration of the timer 142 at the expiration time 148 prior to receipt of the frame end packet 224A, determines that the image frame 160 is an unbounded image frame and performs an error reset operation 144 during the expected VBI 226 corresponding to an error in receipt of the frame end packet 224A, as described with reference to FIG. 3.

In implementations in which the image data controller 140 does not track a count of received image lines, the image data controller 140, responsive to detecting an unbounded image frame, designates the portions of the image frame data 152 (e.g., the data 232) stored in the allocated portion of the memory 132 as invalid and discards the stored portions of the image frame data 152. To illustrate, the image data controller 140 discards the data 232 independently of whether all of the data packets representing the image frame data 152 have been received.

In implementations in which the image data controller 140 tracks a count of received image lines, the image data controller 140, responsive to detecting an unbounded image frame, performs the line count verification 336 to determine whether the stored portions of the image frame data 152 are valid. For example, during the line count verification 336, the image data controller 140 determines whether a value (e.g., M) of the line counter 146 matches the expected line count 136 (e.g., N). For example, the image data controller 140, in response to determining that the value of the line counter 146 (e.g., M) indicates a received line count that does not match (e.g., is not equal to) the expected line count 136 (e.g., N), designates the stored portions of the image frame data 152 (e.g., the data 232A, . . . , the data 232M) as invalid and not representative of the image frame 160, and discards the stored portions of the image frame data 152.

A technical advantage of configuring the timer 142 to expire at the expiration time 148 that is during the expected VBI 226 includes preventing a memory overflow by preventing data of the next image frame being stored with the data of the image frame 160 even if both the frame end packet 224A and the frame start packet 220B are lost during transmission. Having the timer 142 expire at the expiration time 148 with sufficient time remaining in the VBI 226 to complete the error reset operation 144 includes enabling the device 102 to recover from the unbounded image frame prior to receipt of the frame start packet 220B of a next image frame, and preventing the unbounded image frame from causing data of the next image frame to be discarded.

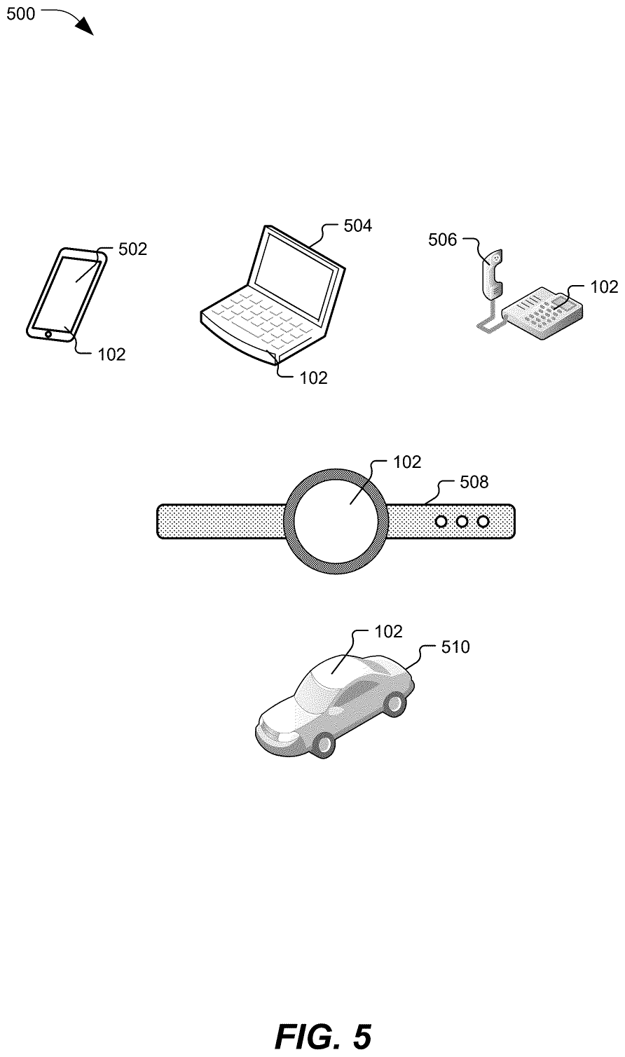

FIG. 5 illustrates various electronic devices that may include or be integrated with the device 102 (that includes the image data controller 140). For example, a mobile phone device 502, a laptop computer device 504, a fixed location terminal device 506, a wearable device 508, or a vehicle 510 (e.g., an automobile or an aerial device) may include the device 102. The devices 502, 504, 506 and 508 and the vehicle 510 illustrated in FIG. 5 are merely exemplary. Other electronic devices may also feature the device 102 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices (e.g., watches, glasses), Internet of things (IoT) devices, servers, routers, electronic devices implemented in vehicles (e.g., autonomous vehicles), or any other device that stores or retrieves data or computer instructions, or any combination thereof.

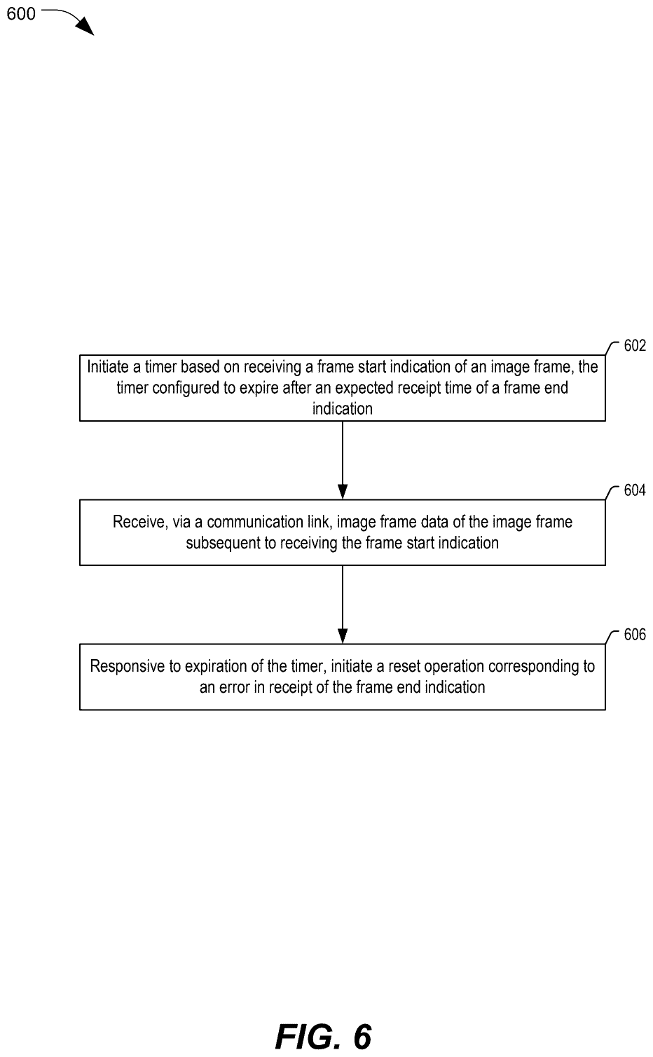

Referring to FIG. 6, a particular implementation of a method 600 of unbounded frame detection is shown. In a particular aspect, one or more operations of the method 600 are performed by at least one of the image data controller 140, the one or more processors 190, the device 102, the system 100 of FIG. 1, or a combination thereof.

The method 600 includes, at block 602, initiating a timer based on receiving a frame start indication of an image frame, the timer configured to expire after an expected receipt time of a frame end indication. For example, the image data controller 140 initiates a timer 142 based on receiving a frame start indication 150 of an image frame 160, as described with reference to FIGS. 1 and 2. The timer 142 is configured to expire after an expected receipt time 134 of a frame end indication 154.

The method 600 also includes, at block 604, receiving, via a communication link, image frame data of the image frame subsequent to receiving the frame start indication. For example, the image data controller 140 receives, via the communication link 112, the image frame data 152 of the image frame 160 subsequent to receiving the frame start indication 150, as described with reference to FIGS. 1 and 2.

The method 600 further includes, at block 606, responsive to expiration of the timer, initiating a reset operation corresponding to an error in receipt of the frame end indication. For example, the image data controller 140, responsive to expiration of the timer 142, initiates an error reset operation 144 corresponding to an error in receipt of the frame end indication 154, as described with reference to FIGS. 3 and 4.

The method 600 thus enables the device 102 to recover from an unbounded image frame prior to receipt of a next frame start indication. For example, the error reset operation 144 completes prior to the expected receipt time of a next frame start indication. The unbounded image frame does not cause image data of a next image frame to be designated as invalid.

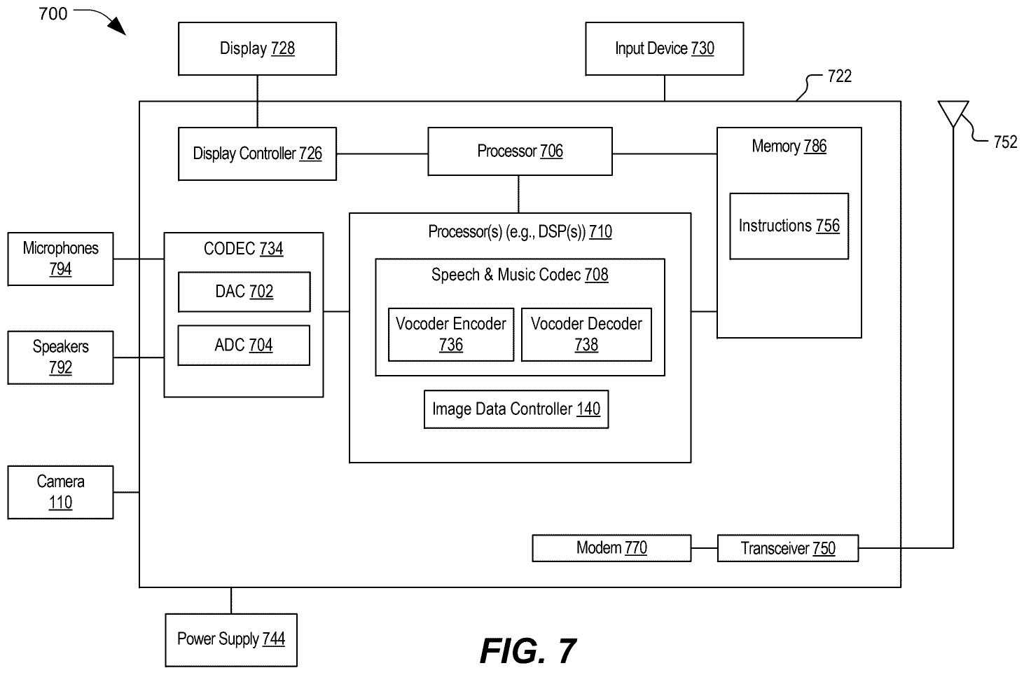

The method 600 of FIG. 6 may be implemented by a field-programmable gate array (FPGA) device, an application-specific integrated circuit (ASIC), a processing unit such as a CPU, a digital signal processor (DSP), a controller, another hardware device, firmware device, or any combination thereof. As an example, the method 600 of FIG. 6 may be performed by a processor that executes instructions, such as described with reference to FIG. 7.

Referring to FIG. 7, a block diagram of a particular illustrative implementation of a device is depicted and generally designated 700. In various implementations, the device 700 may have more or fewer components than illustrated in FIG. 7. In an illustrative implementation, the device 700 may correspond to the device 102. In an illustrative implementation, the device 700 may perform one or more operations described with reference to FIGS. 1-6.

In a particular implementation, the device 700 includes a processor 706 (e.g., a CPU). The device 700 may include one or more additional processors 710 (e.g., one or more DSPs). In a particular aspect, the one or more processors 190 of FIG. 1 correspond to the processor 706, the processors 710, or a combination thereof. The processors 710 may include the image data controller 140, a speech and music coder-decoder (CODEC) 708 that includes a voice coder (“vocoder”) encoder 736 and/or a vocoder decoder 738, or a combination thereof.

The device 700 may include a memory 786 and a CODEC 734. The memory 786 may include instructions 756 that are executable by the one or more additional processors 710 (or the processor 706) to implement the functionality described with reference to the image data controller 140. In a particular aspect, the memory 786 corresponds to the memory 132 of FIG. 1. The device 700 may include a modem 770 coupled, via a transceiver 750, to an antenna 752.

The device 700 may include a display 728 coupled to a display controller 726. A speaker 792 and a microphone 794 may be coupled to the CODEC 734. The CODEC 734 may include a digital-to-analog converter (DAC) 702, an analog-to-digital converter (ADC) 704, or both. In a particular implementation, the CODEC 734 may receive analog signals from the microphone 794, convert the analog signals to digital signals using the analog-to-digital converter 704, and provide the digital signals to the speech and music codec 708. The speech and music codec 708 may process the digital signals. In a particular implementation, the speech and music codec 708 may provide digital signals to the CODEC 734. The CODEC 734 may convert the digital signals to analog signals using the digital-to-analog converter 702 and may provide the analog signals to the speaker 792.

The device 700 may include the camera 110. In a particular implementation, the processor(s) 710 may receive an input image signal from the camera 110 and provide the input image signal to the image data controller 140. The image data controller 140 (and/or the processor(s) 710) may process the input image signal to generate an output image signal, and provide the output image signal to the display 728 for visual display, to the memory 786 for storage, to the modem 770 for transmission to a remote device, or a combination thereof.

In a particular implementation, the device 700 may be included in a system-in-package or system-on-chip device 722. In a particular implementation, the memory 786, the processor 706, the processors 710, the display controller 726, the CODEC 734, and the modem 770 are included in the system-in-package or system-on-chip device 722. In a particular implementation, an input device 730 and a power supply 744 are coupled to the system-in-package or the system-on-chip device 722. Moreover, in a particular implementation, as illustrated in FIG. 7, the display 728, the input device 730, the speaker 792, the microphone 794, the camera 110, the antenna 752, and the power supply 744 are external to the system-in-package or the system-on-chip device 722. In a particular implementation, each of the display 728, the input device 730, the speaker 792, the microphone 794, the camera 110, the antenna 752, and the power supply 744 may be coupled to a component of the system-in-package or the system-on-chip device 722, such as an interface or a controller.

The device 700 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for initiating a timer based on receiving a frame start indication of an image frame, the timer configured to expire after an expected receipt time of a frame end indication. For example, the means for initiating a timer can correspond to the image data controller 140, the one or more processors 190, the device 102, the system 100 of FIG. 1, the processor 706, the processor(s) 710, the device 700, one or more other circuits or components configured to initiate a timer, or any combination thereof.

The apparatus also includes means for receiving, via a communication link, image frame data of the image frame subsequent to receiving the frame start indication. For example, the means for receiving can correspond to the image data controller 140, the one or more processors 190, the device 102, the system 100 of FIG. 1, the processor 706, the processor(s) 710, the device 700, the modem 770, the transceiver 750, the antenna 752, one or more other circuits or components configured to receive image frame data, or any combination thereof.

The apparatus further includes means for initiating a reset operation corresponding to an error in receipt of the frame end indication, the reset operation initiated responsive to expiration of the timer. For example, the means for initiating a reset operation can correspond to the image data controller 140, the one or more processors 190, the device 102, the system 100 of FIG. 1, the processor 706, the processor(s) 710, the device 700, one or more other circuits or components configured to initiate a reset operation, or any combination thereof.

In some implementations, a non-transitory computer-readable medium (e.g., a computer-readable storage device, such as the memory 786) includes instructions (e.g., the instructions 756) that, when executed by one or more processors (e.g., the one or more processors 710 or the processor 706), cause the one or more processors to initiate a timer (e.g., the timer 142) based on receiving a frame start indication (e.g., the frame start indication 150) of an image frame (e.g., the image frame 160), the timer configured to expire after an expected receipt time (e.g., the expected receipt time 134) of a frame end indication (e.g., the frame end indication 154). The instructions also cause the one or more processors to receive, via a communication link (e.g., the communication link 112), image frame data (e.g., the image frame data 152, the data 232) of the image frame subsequent to receiving the frame start indication. The instructions further cause the one or more processors to, responsive to expiration of the timer, initiate a reset operation (e.g., the error reset operation 144) corresponding to an error in receipt of the frame end indication.

Particular aspects of the disclosure are described below in sets of interrelated Examples:

According to Example 1, a device includes memory configured to store image frame data of an image frame; and one or more processors configured to initiate a timer based on receiving a frame start indication of the image frame, the timer configured to expire after an expected receipt time of a frame end indication; receive, via a communication link, the image frame data subsequent to receiving the frame start indication; and responsive to expiration of the timer, initiate a reset operation corresponding to an error in receipt of the frame end indication.

Example 2 includes the device of Example 1, wherein the one or more processors are configured to disable the timer responsive to receiving the frame end indication.

Example 3 includes the device of Example 1 or Example 2, wherein the image frame corresponds to an output of a camera coupled to the one or more processors via the communication link.

Example 4 includes the device of any of Examples 1 to 3, wherein the image frame data includes a stream of packets of line data interspersed with blanking intervals.

Example 5 includes the device of any of Examples 1 to 4, wherein the one or more processors are configured to update a line counter based on receiving a packet of line data, wherein the image frame data includes the packet of line data.

Example 6 includes the device of Example 5, wherein the one or more processors are configured to, responsive to expiration of the timer and based on determining that a value of the line counter does not match an expected line count, designate the image frame data as invalid.

Example 7 includes the device of Example 5 or Example 6, wherein the one or more processors are configured to, responsive to expiration of the timer and based on determining that a value of the line counter matches an expected line count, designate the image frame data as valid.

Example 8 includes the device of any of Examples 1 to 7, wherein the reset operation corresponds to reset of one or more hardware blocks associated with receiving the image frame data via the communication link.

Example 9 includes the device of any of Examples 1 to 8, wherein the timer is configured to expire before an expected receipt time of a next frame start indication.

Example 10 includes the device of any of Examples 1 to 9, wherein the timer is configured to expire during an expected vertical blanking interval after the expected receipt time of the frame end indication.

Example 11 includes the device of any of Examples 1 to 10, wherein the reset operation is completed prior to an expected receipt time of a next frame start indication.

Example 12 includes the device of any of Examples 1 to 11, wherein the error corresponds to an unbounded frame error.

Example 13 includes the device of any of Examples 1 to 12, wherein the one or more processors are configured to, responsive to receipt of the frame end indication prior to expiration of the timer, initiate a reset operation corresponding to receipt of the frame end indication.

According to Example 14, a non-transitory computer-readable medium stores instructions that, when executed by one or more processors, cause the one or more processors to initiate a timer based on receiving a frame start indication of an image frame, the timer configured to expire after an expected receipt time of a frame end indication; receive, via a communication link, image frame data of the image frame subsequent to receiving the frame start indication; and responsive to expiration of the timer, initiate a reset operation corresponding to an error in receipt of the frame end indication.

According to Example 15, a method includes initiating, at a device, a timer based on receiving a frame start indication of an image frame, the timer configured to expire after an expected receipt time of a frame end indication; receiving, at the device via a communication link, image frame data of the image frame subsequent to receiving the frame start indication; and responsive to expiration of the timer, initiating a reset operation corresponding to an error in receipt of the frame end indication.

Example 16 includes the method of Example 15, wherein the image frame corresponds to an output of a camera coupled to the device via the communication link.

Example 17 includes the method of Example 15 or Example 16, wherein the image frame data includes a stream of packets of line data interspersed with blanking intervals.

Example 18 includes the method of any of Examples 15 to 17, and further includes updating a line counter based on receiving a packet of line data, wherein the image frame data includes the packet of line data.

Example 19 includes the method of Example 18, and further includes, responsive to expiration of the timer and based on determining that a value of the line counter does not match an expected line count, designating the image frame data as invalid.

Example 20 includes the method of Example 18, and further includes, responsive to expiration of the timer and based on determining that a value of the line counter matches an expected line count, designating the image frame data as valid.

Example 21 includes the method of any of Examples 15 to 20, wherein the reset operation corresponds to reset of one or more hardware blocks associated with receiving the image frame data via the communication link.

Example 22 includes the method of any of Examples 15 to 21, wherein the timer is configured to expire before an expected receipt time of a next frame start indication.

Example 23 includes the method of any of Examples 15 to 22, wherein the timer is configured to expire during an expected vertical blanking interval after the expected receipt time of the frame end indication.

Example 24 includes the method of any of Examples 15 to 23, wherein the reset operation is completed prior to an expected receipt time of a next frame start indication.

Example 25 includes the method of any of Examples 15 to 24, wherein the error corresponds to an unbounded frame error.

Example 26 includes the method of any of Examples 15 to 25, and further includes, responsive to receipt of the frame end indication prior to expiration of the timer, initiating a reset operation corresponding to receipt of the frame end indication.

According to Example 27, an apparatus includes means for initiating a timer based on receiving a frame start indication of an image frame, the timer configured to expire after an expected receipt time of a frame end indication; means for receiving, via a communication link, image frame data of the image frame subsequent to receiving the frame start indication; and means for initiating a reset operation corresponding to an error in receipt of the frame end indication, the reset operation initiated responsive to expiration of the timer.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
memory configured to store image frame data of an image frame; and
one or more processors configured to:
initiate a timer based on receiving a frame start indication of the image frame, the timer configured to expire after an expected receipt time of a frame end indication;
receive, via a communication link, the image frame data subsequent to receiving the frame start indication; and
responsive to expiration of the timer, initiate a reset operation corresponding to an error in receipt of the frame end indication.

2. The device of claim 1, wherein the one or more processors are configured to disable the timer responsive to receiving the frame end indication.

3. The device of claim 1, wherein the image frame corresponds to an output of a camera coupled to the one or more processors via the communication link.

4. The device of claim 1, wherein the image frame data includes a stream of packets of line data interspersed with blanking intervals.

5. The device of claim 1, wherein the one or more processors are configured to update a line counter based on receiving a packet of line data, wherein the image frame data includes the packet of line data.

6. The device of claim 5, wherein the one or more processors are configured to, responsive to expiration of the timer and based on determining that a value of the line counter does not match an expected line count, designate the image frame data as invalid.

7. The device of claim 5, wherein the one or more processors are configured to, responsive to expiration of the timer and based on determining that a value of the line counter matches an expected line count, designate the image frame data as valid.

8. The device of claim 1, wherein the reset operation corresponds to reset of one or more hardware blocks associated with receiving the image frame data via the communication link.

9. The device of claim 1, wherein the timer is configured to expire before an expected receipt time of a next frame start indication.

10. The device of claim 1, wherein the timer is configured to expire during an expected vertical blanking interval after the expected receipt time of the frame end indication.

11. The device of claim 1, wherein the reset operation is completed prior to an expected receipt time of a next frame start indication.

12. The device of claim 1, wherein the error corresponds to an unbounded frame error.

13. The device of claim 1, wherein the one or more processors are configured to, responsive to receipt of the frame end indication prior to expiration of the timer, initiate a reset operation corresponding to receipt of the frame end indication.

14. A non-transitory computer-readable medium storing instructions that, when executed by one or more processors, cause the one or more processors to:
initiate a timer based on receiving a frame start indication of an image frame, the timer configured to expire after an expected receipt time of a frame end indication;
receive, via a communication link, image frame data of the image frame subsequent to receiving the frame start indication; and
responsive to expiration of the timer, initiate a reset operation corresponding to an error in receipt of the frame end indication.

15. A method comprising:
initiating, at a device, a timer based on receiving a frame start indication of an image frame, the timer configured to expire after an expected receipt time of a frame end indication;
receiving, at the device via a communication link, image frame data of the image frame subsequent to receiving the frame start indication; and
responsive to expiration of the timer, initiating a reset operation corresponding to an error in receipt of the frame end indication.

16. The method of claim 15, wherein the image frame corresponds to an output of a camera coupled to the device via the communication link.

17. The method of claim 15, wherein the image frame data includes a stream of packets of line data interspersed with blanking intervals.

18. The method of claim 15, further comprising updating a line counter based on receiving a packet of line data, wherein the image frame data includes the packet of line data.

19. The method of claim 18, further comprising, responsive to expiration of the timer and based on determining that a value of the line counter does not match an expected line count, designating the image frame data as invalid.

20. The method of claim 18, further comprising, responsive to expiration of the timer and based on determining that a value of the line counter matches an expected line count, designating the image frame data as valid.
